(19) United States
(12) Patent Application Publication
(10) Pub. No.: US 2015/0083198 A1
(43) Pub. Date: Mar. 26, 2015

(54) PHOTOVOLTAIC POWER GENERATION SYSTEM

(71) Applicant: KABUSHIKI KAISHA TOSHIBA, Tokyo (JP)

(72) Inventors: Tomohiko JIMBO, Fujisawa (JP); Biswas DEBASISH, Shiki (JP); Kei MATSUOKA, Kawasaki (JP); Yoshiaki HASEGAWA, Tokyo (JP)

(21) Appl. No.: 14/489,621

(22) Filed: Sep. 18, 2014

(30) Foreign Application Priority Data
Sep. 20, 2013 (JP) 2013-196134

(51) Int. Cl. H02S 20/23

(52) U.S. Cl. CPC H02S 20/23
USPC 136/251

(57) ABSTRACT

According to an embodiment, a photovoltaic power generation system includes a photovoltaic array group and a windbreak. The photovoltaic array group includes a plurality of photovoltaic arrays, each of the photovoltaic arrays including a plurality of solar panels and a support structure which supports the solar panels. The windbreak is arranged at least partly around the photovoltaic array group and includes a plurality of windbreaker elements, each of the windbreaker having a horizontal section of an airfoil shape or a plurality of windbreaker elements each formed by combining a plurality of flat plates.

### CROSS-REFERENCE TO RELATED APPLICATIONS

This application is based upon and claims the benefit of priority from Japanese Patent Application No. 2013-196134, filed Sep. 20, 2013, the entire contents of which are incorporated herein by reference.

### FIELD

Embodiments described herein relate generally to a photovoltaic power generation system.

### BACKGROUND

In recent years, concerns about environmental issues are boosting the global installation of photovoltaic power generation systems that generate power using sunlight, and mega solar power plants equipped with a large-scale photovoltaic power generation system have been constructed at locations throughout the world. In the photovoltaic power generation system, a number of solar panels are arranged. These solar panels are supported and fixed by a support structure including a rack and a base. The support structure is required to have a strength capable of withstanding wind pressure and the like acting on the solar panels.

However, the installation cost of support structures makes up a large proportion of the installation cost of a photovoltaic power generation system. This proportion is larger especially in a mega solar system in which 10,000 or more solar panels are arranged. It is therefore required to reduce the installation costs of the support structures. The reduction of the installation costs of support structures can be achieved by reducing the weight of the support structures. However, it is difficult to reduce the weight of the support structures while ensuring their ability to withstand wind pressure and the like.

It is desirable to be able to reduce the installation costs of support structures in a photovoltaic power generation system.

### BRIEF DESCRIPTION OF THE DRAWINGS

FIG. 1 is a perspective view showing a photovoltaic power generation system according to an embodiment;

FIG. 2 is a plan view showing the photovoltaic power generation system shown in FIG. 1;

FIG. 3 is a plan view schematically, showing the flow of air when a northeastern wind blows on the photovoltaic power generation system shown in FIG. 1;

FIGS. 4A and 4E are views showing states in which the flow of air is changed by windbreaker elements shown in FIG. 1;

FIG. 5 is a view for explaining the arrangement relationship between the windbreaker elements and photovoltaic arrays according to the embodiment;

FIG. 6 is a plan view showing an example in which the windbreaker elements are arranged around a photovoltaic array group including photovoltaic arrays with unaligned ends;

FIG. 7 is a plan view showing a photovoltaic power generation system according to Comparative Example 1;

FIG. 8 is a plan view showing a photovoltaic power generation system according to Comparative Example 2;

FIGS. 9A and 9B are schematic views for explaining conditions used for numerical analysis;

FIGS. 10A and 10B are views showing wind force coefficient distributions in a photovoltaic array group shown in FIG. 7 which are obtained by numerical analysis;

FIGS. 11A and 11B are views showing wind force coefficient distributions in a photovoltaic array group shown in FIG. 8 which are obtained by numerical analysis;

FIG. 12 is a perspective view showing a photovoltaic power generation system according to another embodiment; and

FIG. 13 is a plan view showing the photovoltaic power generation system shown in FIG. 12.

### DETAILED DESCRIPTION

In general, according to an embodiment, a photovoltaic power generation system includes a photovoltaic array group and a windbreak. The photovoltaic array group includes a plurality of photovoltaic arrays, each of the photovoltaic arrays including a plurality of solar panels and a support structure which supports the solar panels. The windbreak is arranged at least partly around the photovoltaic array group and includes a plurality of windbreaker elements, each of the windbreaker having a horizontal section of an airfoil shape or a plurality of windbreaker elements each formed by combining a plurality of flat plates.

Concerning a photovoltaic power generation system, JIS (Japanese Industrial Standards) C8955 defines designing a solar panel assuming four kinds of loads: a dead load caused by the mass of a photovoltaic array itself, a wind pressure load caused by wind pressure, a snow load caused by snow accumulated on the surface of a solar panel, and a seismic load caused by a seismic force. The load combination changes depending on the installation environment. The wind pressure load is a load that needs to be taken into consideration in many solar power plants, and an approximation that calculates a wind pressure load applied to a photovoltaic array from a wind velocity is applied. When applying this standard, “in case there is a plurality of racks, a wind force coefficient calculated by the formula may be applied to the peripheral ends, and ½ the value may be applied to the central portion”. However, there is no clear definition of what constitutes the central portion. For this reason, when designing a photovoltaic power generation system, it is important to appropriately estimate the region (central portion) where ½ the wind force coefficient at the peripheral ends is used so that safety can be ensured.

Embodiments will now be described with reference to the accompanying drawings. In the following embodiments, like reference numerals denote like elements, and a repetitive description thereof will be omitted.

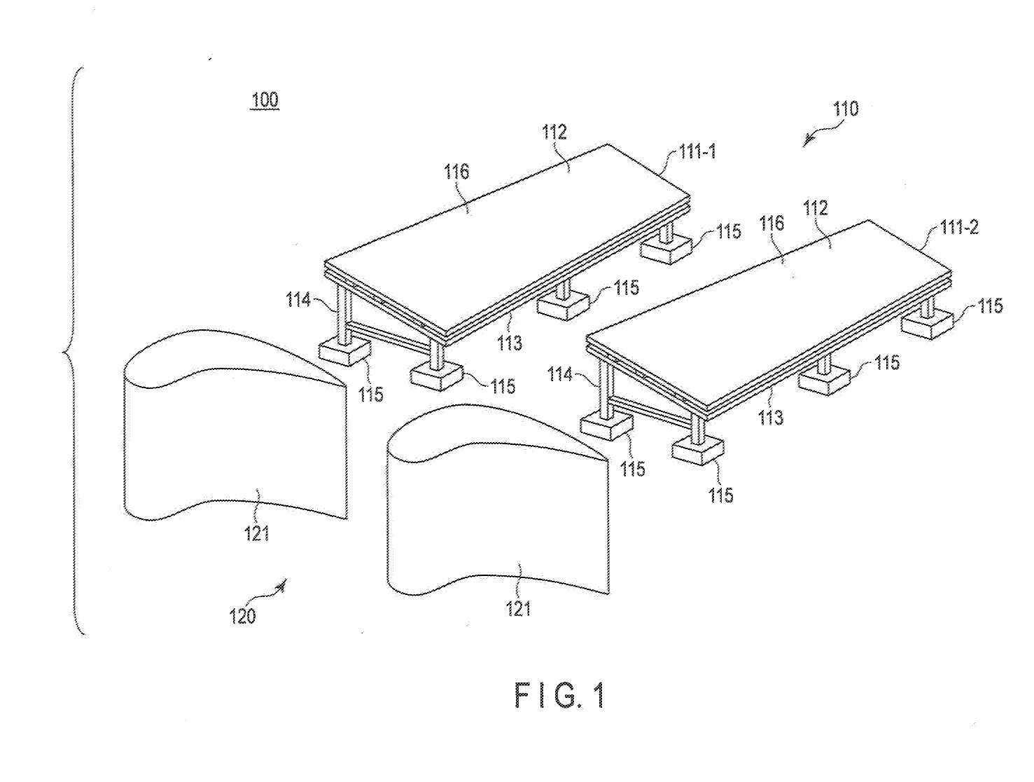

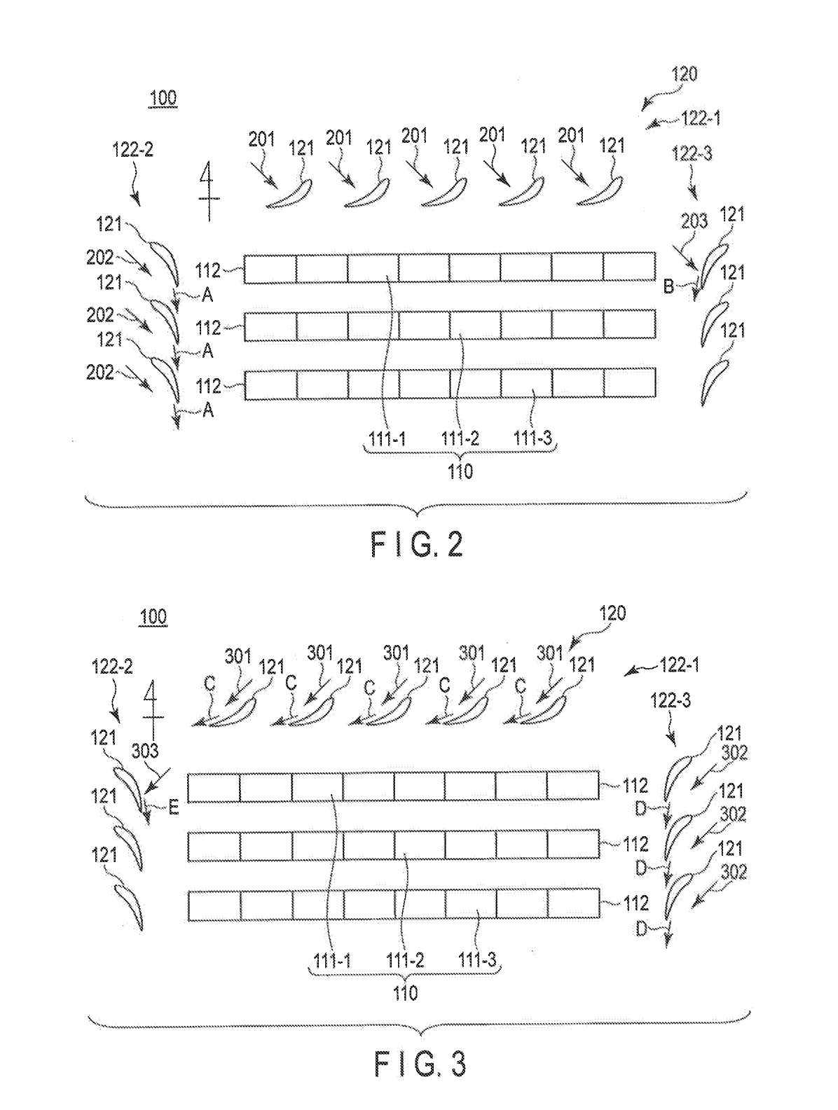

FIG. 1 is a perspective view schematically showing a photovoltaic power generation system 100 according to an embodiment. FIG. 2 is a plan view schematically showing the photovoltaic power generation system 100. As shown in FIG. 2, the photovoltaic power generation system 100 includes a photovoltaic array group 110 including a plurality of photovoltaic arrays 111, and a windbreak 120 arranged around the photovoltaic array group 110 and including a plurality of windbreaker elements 121. In the example shown in FIG. 2, three photovoltaic arrays 111-1 to 111-3 are juxtaposed in a state in which their ends are aligned. FIG. 1 illustrates the two photovoltaic arrays 111-1 and 111-2 and two windbreaker elements 121.

As shown in FIG. 1, each photovoltaic array 111 includes a plurality of solar panels 112 which receive sunlight and generate electric power, and a support structure 113 which supports and fixes the solar panels 112. The support structure 113 includes a rack 114 which supports the solar panels 112 tilting at a given angle from the level surface, and concrete bases 115 which fix the rack 114 on the ground. Referring to FIG. 2, each rectangular block represents one solar panel 112. In the example of FIG. 2, eight solar panels 112 connected by conductive connection members are arranged in each photovoltaic array 111.

In general, the solar panels 112 are installed in a tilted state from the viewpoint of power generation efficiency. For example, in regions at high latitudes in the Northern Hemisphere such as Japan, the solar panels 112 are installed while tilted so that their light receiving surfaces 116 face the south. The angle made by the level surface and the light receiving surface 116 is determined in consideration of various conditions such as the latitude and environment of the installation location.

In this embodiment, a case is assumed where the solar panels 112 are arranged southward. In this case, the three photovoltaic arrays 111-1 to 111-3 are juxtaposed in a north-south direction. In each of the photovoltaic arrays 111-1 to 111-3, the solar panels 112 are arrayed in an east-west direction. In the example of FIG. 2, the windbreaker elements 121 are arranged on the west, east, and north sides of the photovoltaic array group 110.

In this embodiment, each windbreaker element 121 has an airfoil-shaped horizontal section. More specifically, each windbreaker element 121 has an asymmetric airfoil-shaped horizontal section. The windbreak 120 changes the flow of air that flows from the back side of the Photovoltaic array group 110 toward the photovoltaic array group 110. The back side of the photovoltaic array group 110 here indicates the side facing the back surfaces of the solar panels 112. In this embodiment in which the solar panels 112 are arranged southward, a wind which blows from the back side of the photovoltaic array group 110 toward the photovoltaic array group 110 indicates a wind including some wind flow from the north to the south, for example, a north wind, a northeastern wind, or a northwestern wind.

For example, when a northwestern wind blows, as shown in FIG. 2, a wind 201 is blocked by a windbreaker element group 122-1 arranged on the north side (that is, on the back side) of the photovoltaic array group 110. A wind. 202 is deflected (that is, turned) by a windbreaker element group 122-2 arranged on the west side of the photovoltaic array group 110 and changes to a wind that blows southward, as indicated by an arrow A. A wind 203 is deflected by a windbreaker element group 122-3 arranged on the east side of the photovoltaic array group 110 and changes to a wind that blows southward, as indicated by an arrow B. The windbreak 120 thus prevents at least some of the wind which blows from the back side toward the photovoltaic array group 110 from directly striking the solar panels 112. This reduces the wind directly striking the solar panels 112 and lowers the wind pressure acting on the solar panels 112.

FIG. 3 schematically shows the flow of air when a northeastern wind blows on the photovoltaic power generation system shown 100. A wind 301 is deflected by the windbreaker element group 122-1 and changes to a wind that blows westward, as indicated by an arrow C. A wind 302 is deflected by the windbreaker element group 122-3 and changes to a wind that blows southward, as indicated by an arrow D. A wind 303 is deflected by the windbreaker element group 122-2 and changes to a wind that blows southward, as indicated by an arrow E. The windbreak 120 thus prevents at least some of the wind which blows from the back side toward the photovoltaic array group 110 from directly striking the back surfaces of the solar panels 112. This reduces the wind directly striking the solar panels 112 and lowers the wind pressure acting on the solar panels 112.

In this embodiment, the horizontal cross section of the windbreaker element 121 has an airfoil shape, thereby reducing the wind pressure (wind load) acting on the windbreaker element 121 itself. It is therefore possible to lower the strength of the windbreaker elements 121 and reduce the installation cost of the windbreaker elements 121.

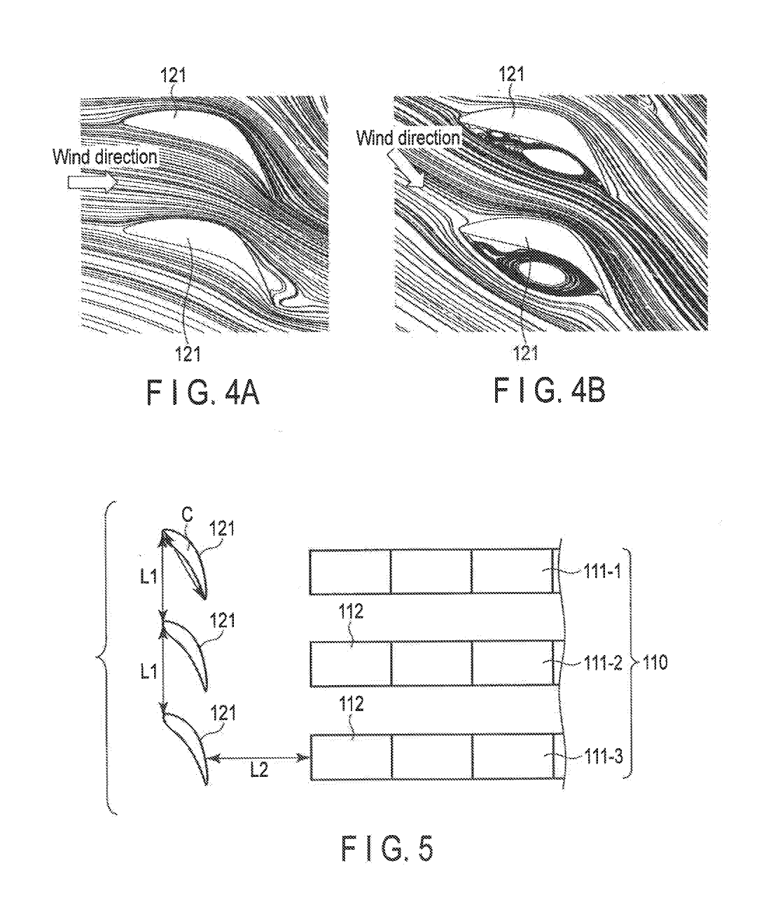

FIGS. 4A and 4B are views showing the flow of air around the windbreaker elements 121 obtained by numerical analysis when viewed from the upper side. The direction of the influent wind changes by about 45° between FIGS. 4A and 4B. As is apparent from FIGS. 4A and 4E, the flow of air changes its direction when passing between the windbreaker elements 121. The flow of air can be changed by arranging the windbreaker elements 121 around the photovoltaic array group 110. The wind that directly strikes the photovoltaic arrays 111 can thus be reduced. It is therefore possible to reduce the wind pressure acting on the solar panels and reduce the weight of the support structure 113 while ensuring safety.

The arrangement relationship between the photovoltaic arrays 111 and the windbreaker elements 121 will be described in detail with reference to FIG. 5. FIG. 5 is an enlarged view of part of the photovoltaic power generation system. For example, the windbreaker elements 121 are arranged so that a distance (windbreaker element interval) L1 between the windbreaker elements 121 becomes equal to or less than a chord length C, and a distance L2 between the windbreaker elements 121 and the photovoltaic arrays 111 falls within the range of 1 to 2 m. The chord length C indicates the length of a line segment that connects the leading edge and the trailing edge of the chord, as shown in FIG. 5. The dimensions of the windbreaker element 121 are determined in accordance with the arrangement of the photovoltaic array 111 and the state of the installation location within the range capable of ensuring the windbreaker element interval L1 and the distance L2 between the windbreaker elements 121 and the photovoltaic arrays 111.

Note that the windbreaker elements 121 may be arranged all around the photovoltaic array group 110 or partly around the photovoltaic array group 110 in accordance with the wind state of the installation environment. For example, when installing the photovoltaic power generation system 100 in a region where a northwestern wind blows strongly but a northeastern wind does not, the windbreaker elements 121 are arranged on the north and west sides of the photovoltaic array group 110. The windbreaker elements 121 are independent, and not all the windbreaker elements 121 need always have the same dimensions and shape. In addition, the windbreaker element interval L1 need not be the same for all the windbreaker elements 121. The windbreaker element interval L1 can arbitrarily be set within a range less than the chord length C for the individual windbreaker elements 121.

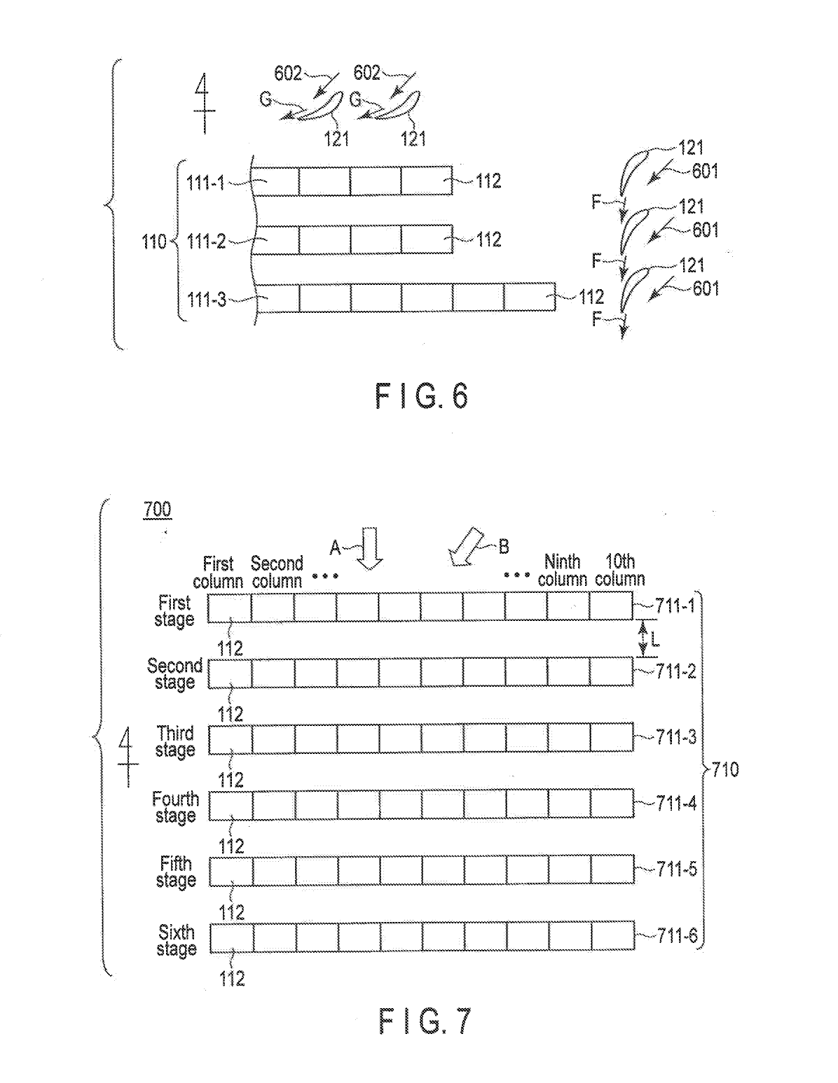

The windbreak 120 may be installed not only when the photovoltaic arrays 111 have aligned ends, as shown in FIG. 2, but also when the ends have step differences in the photovoltaic array group 110, as shown in FIG. 6. As shown in FIG. 6, when a northeastern wind blows, a wind 601 is deflected by the windbreaker element group 122-1 and changes to a wind that blows westward, as indicated by an arrow F. A wind. 602 is deflected by the windbreaker element group 122-3 and changes to a wind that blows southward, as indicated by an arrow G. This reduces the wind directly striking the solar panels 112 and lowers the wind pressure acting on the solar panels 112.

FIG. 7 schematically shows a photovoltaic power generation system 700 according to Comparative Example 1.

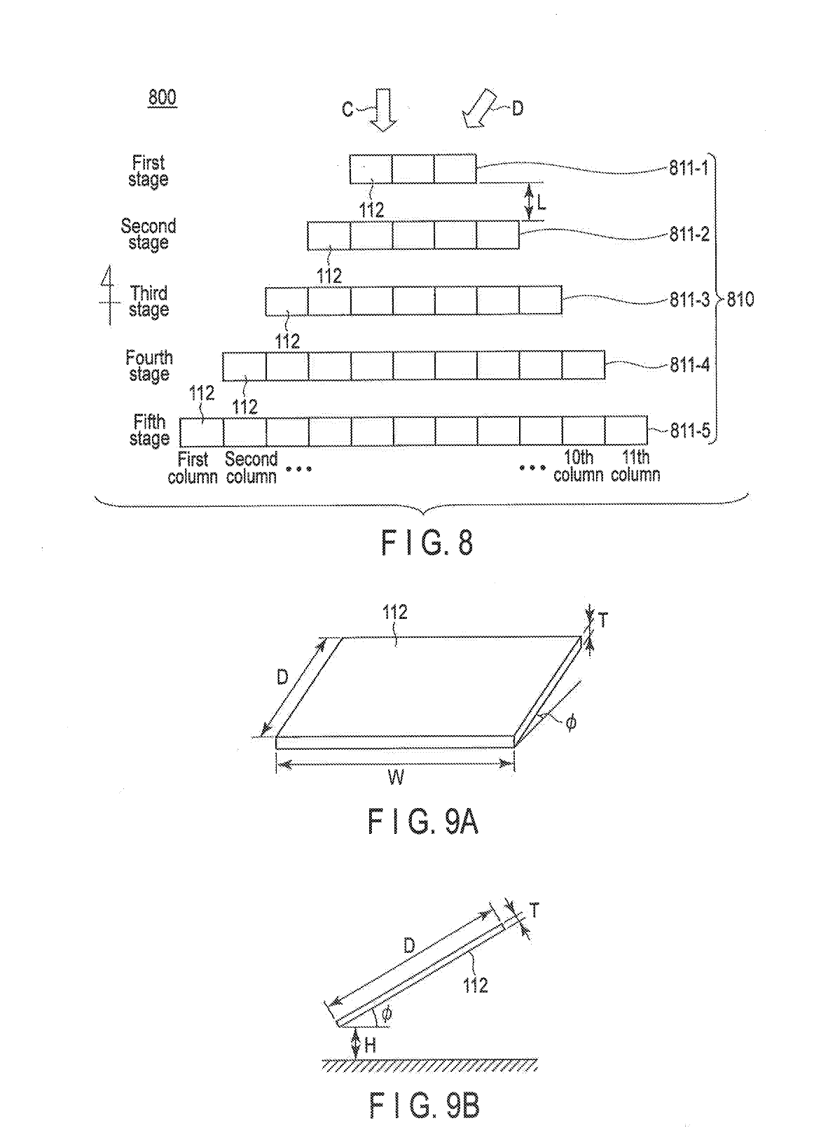

FIG. 8 schematically shows a photovoltaic power generation system 800 according to Comparative Example 2. The photovoltaic power generation systems 700 and 800 shown in FIGS. 7 and 8 include no windbreak, unlike the photovoltaic power generation system 100 shown in FIG. 1. In a photovoltaic array group 710 of the photovoltaic power generation system 700, each of photovoltaic arrays 711 of six columns includes 10 solar panels 112. A photovoltaic array group 810 of the photovoltaic power generation system 800 shown in FIG. 8 includes photovoltaic arrays 811 of five columns, and the number of solar panels 112 changes between the photovoltaic arrays 811. A photovoltaic array 811-1 of the first column located at the northernmost end includes three solar panels 112, and a photovoltaic array 811-2 of the second column adjacent to the south side of the photovoltaic array 811-1 includes five solar panels 112. In this way, the number of solar panels 112 increases by two as the number of columns increases (that is, the position moves southward). In this case, a photovoltaic array 811-5 of the fifth column includes 11 solar panels 112.

The present inventors obtained wind force coefficient distributions in the photovoltaic array groups 710 and 810 of the photovoltaic power generation systems 700 and 800 by numerical analysis. Analytic models used in the numerical analysis will be described. In the numerical analysis, elements (for example, a rack and a base) other than the solar panel 112 have little effect on the wind flow and are not taken into consideration. For the photovoltaic power generation system 700, as shown in FIG. 9A, a width W of the solar panel 112 is set to 1,500 mm, a depth D is set to 3,000 mm, and a thickness T is set to 100 mm. Additionally, as shown in FIG. 9B, a height H of the solar panel 112 is set to 500 mm, and the angle φ is set to 30°. As shown in FIG. 7, a distance L between the photovoltaic arrays 711 is set to 3,000 mm. The solar panels 112 are arranged southward. The wind directions are set to a direction from the north to the south (direction indicated by an arrow A in FIG. 7) and a direction from the northeast to the southwest (direction indicated by an arrow B in FIG. 7). The wind velocity is set to 30 m/s.

For the photovoltaic power generation system 800, the width W of the solar panel 112 is set to 1,500 mm, the depth D is set to 2,945 mm, and the thickness T is set to 100 mm. Additionally, the height H of the solar panel 112 is set to 730 mm, and the angle φ is set to 10°. As shown in FIG. 6, the distance L between the photovoltaic arrays 811 is set to 1,700 mm. The solar panels 112 are arranged southward. The wind directions are set to a direction from the north to the south (direction indicated by an arrow C in FIG. 8) and a direction from the northeast to the southwest (direction indicated by an arrow D in FIG. 8). The wind velocity is set to 30 m/s.

A wind force coefficient C is defined by equation (1) below. In equation (1), a direction from the back surfaces of the solar panels 112 to the light receiving surfaces 116 is defined as positive concerning the wind force coefficient C. The wind force coefficient C represents that the larger the absolute value is, the higher the wind pressure acting on the solar panel 112 is.

$$C = \int \frac{{P}_{1} - {P}_{u}}{\frac{ρ {U}^{2} A}{2}} d A \qquad ( 2 )$$

P₁ is the wind pressure acting on the back surface of the solar panel 112, Pᵤ is the wind pressure acting on the light receiving surface 116 of the solar panel 112, ρ and U are the density and flow velocity of a fluid (air), respectively, and A is the area of the light receiving surface 116 or back surface of the solar panel 112.

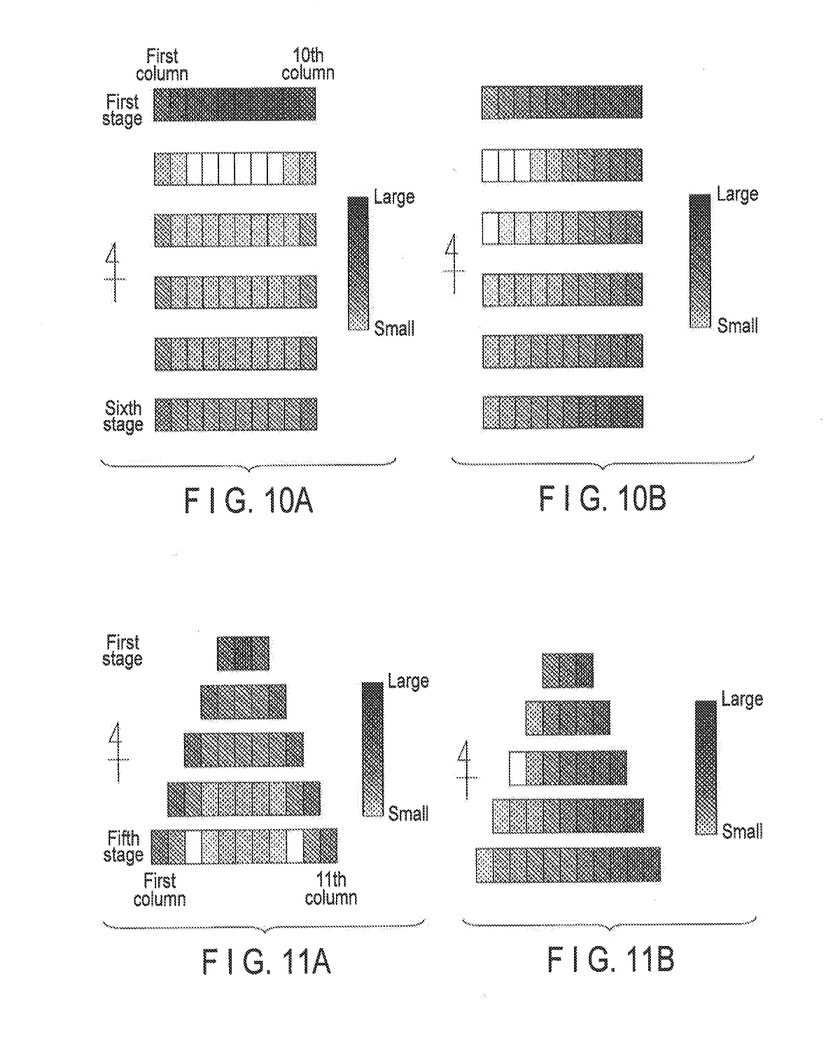

FIG. 10A shows a wind force coefficient distribution in the photovoltaic array group 710 obtained by numerical analysis in a case where the wind direction is the direction indicated by the arrow A in FIG. 7 (that is, a case where a north wind is assumed), FIG. 10B shows a wind force coefficient distribution in the photovoltaic array group 710 obtained by numerical analysis in a case where the wind direction is the direction indicated, by the arrow B in FIG. 7 (that is, a case where a northeastern wind is assumed). FIG. 11A shows a wind force coefficient distribution in the photovoltaic array group 810 obtained by numerical analysis in a case where the wind direction is the direction indicated by the arrow C in FIG. 8 (that is, a case where a north wind is assumed). FIG. 11B shows a wind force coefficient distribution in the photovoltaic array group 810 obtained by numerical analysis in a case where the wind direction is the direction indicated by the arrow D in FIG. 8 (that is, a case where a northeastern wind is assumed). Referring to FIGS. 10A, 10B, 11A, and 11B, the deeper the color is, the larger the value of the wind force coefficient is, and the lighter the color is, the smaller the value of the wind force coefficient is.

Referring to FIGS. 10A and 10B, the wind force coefficient tends to be larger for the solar panel 112 on the windward side in both the wind directions A and E. More specifically, in FIG. 10A, the wind force coefficients C are maximized in the photovoltaic array 711-1 of the first stage and minimized in the photovoltaic array 711-2 of the second stage. The wind force coefficients become large toward the photovoltaic arrays 711 on the leeward side. In the photovoltaic array 711-1 of the first stage on the windward side, the wind force coefficients are smaller for the solar panels 112 of the first, second, ninth, and 10th columns located at the ends as compared to the solar panels 112 of the third to eighth columns located at the center. In the photovoltaic arrays 711-2 to 711-6 of the second to sixth stages, the wind force coefficients are large for the solar panels 112 of the first and 10th columns located at the ends as compared to the solar panels 112 of the second to ninth columns located at the center. Referring to FIGS. 11A and 11B, the wind force coefficient tends to be larger for the solar panel 112 on the windward side in both the wind directions C and D. More specifically, in FIG. 11A, the wind force coefficients C are maximized in the photovoltaic array 811-1 of the first stage and become small toward the photovoltaic array 811 on the leeward side.

As described above, the tendency changes between the photovoltaic array group 710 and the photovoltaic array group 810. In the photovoltaic array group 710, a north wind swirls at the two ends and at the center of each photovoltaic array 711. In addition, a northeastern wind strikes the solar panel 112 at the east end (of the 10th column) of each photovoltaic array 711 and then flows through the photovoltaic arrays 711 while being disturbed. On the other hand, in the photovoltaic array group 810, a wind such as a northeastern wind from an oblique direction easily flows to the center region. The above-described difference in tendency probably occurs due to such a difference in the flow of air.

In this embodiment, the windbreak 120 is provided, thereby preventing a wind from directly striking the solar panels 112 at the peripheral ends of the photovoltaic array group 110 and lowering the wind pressure acting on the solar panels 112. For this reason, the central portion described in JIS C8955 described above can be more widely set. It is therefore possible to reduce the installation cost of the racks 114 and the bases 115.

As described above, in the photovoltaic power generation system according to this embodiment, the windbreaker elements are provided at least partly around the photovoltaic array group 110, thereby reducing the wind pressure acting on the solar panels. This makes it possible to ensure safety and reduce the weight of the bases and the racks. It is consequently possible to reduce the installation cost of the bases and the racks.

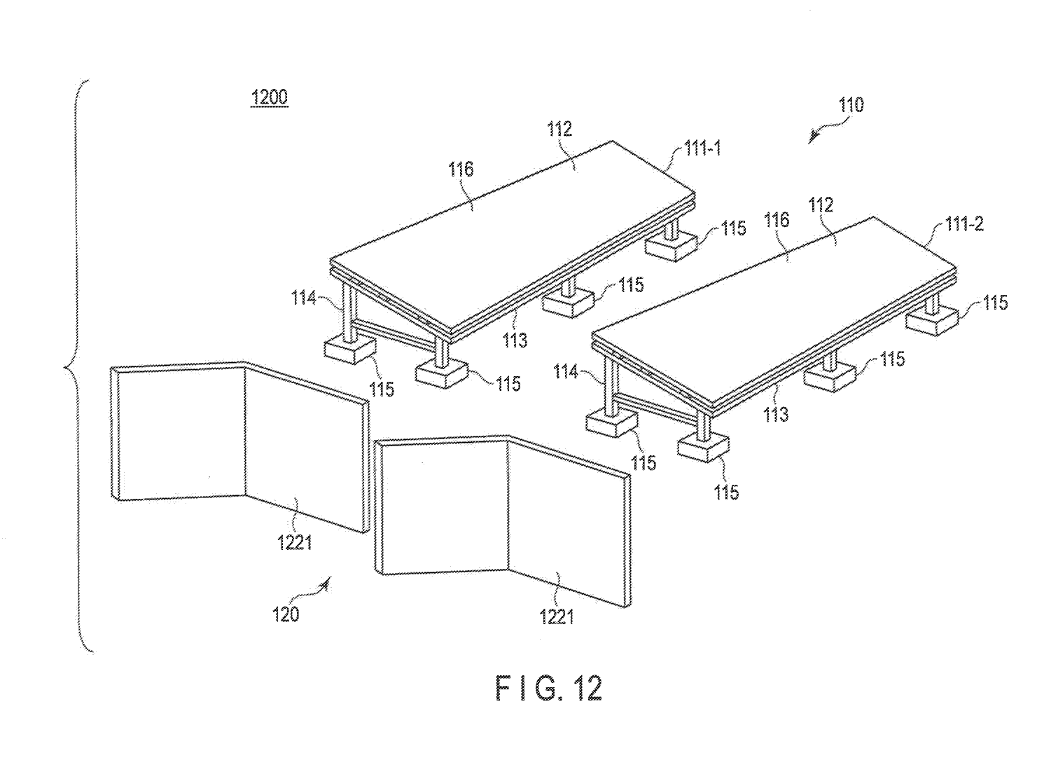

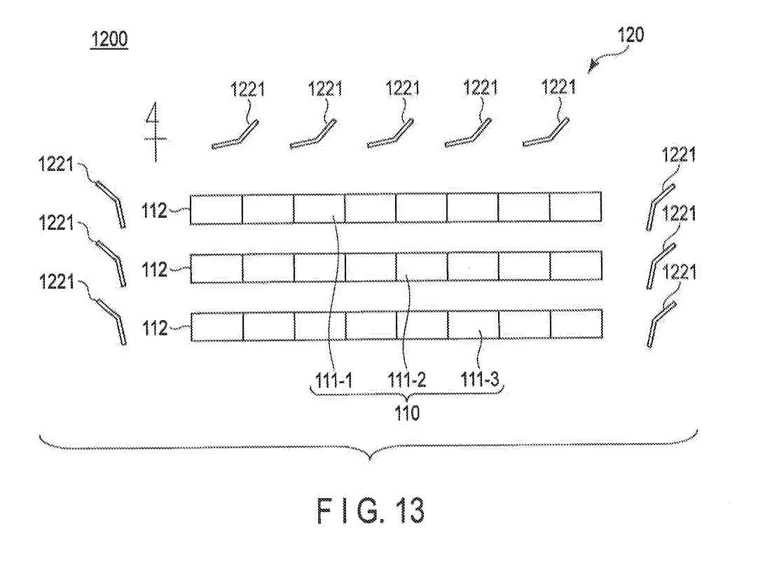

Note that the windbreaker element need not always have an airfoil-shaped horizontal section and can have any other shape as long as it can change the flow of air. FIG. 12 is a perspective view schematically showing a photovoltaic power generation system 1200 according to a modification of the embodiment. FIG. 13 is a plan view schematically showing the photovoltaic power generation system 1200. As shown in FIGS. 12 and 13, the windbreak 120 according to the modification of the embodiment includes a plurality of windbreaker elements 1221 each formed by combining a plurality of (for example, two) flat plates. In the modification of the embodiment as well, the wind pressure acting on the solar panels can be reduced. It is therefore possible to reduce the installation cost of the bases and the racks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A photovoltaic power generation system comprising:
a photovoltaic array group including a plurality of photovoltaic arrays, each of the photovoltaic arrays including a plurality of solar panels and a support structure which supports the solar panels; and
a windbreak arranged at least partly around the photovoltaic array group and including a plurality of windbreaker elements, each of the windbreaker elements having a horizontal section of an airfoil shape or a plurality of windbreaker elements each formed by combining a plurality of flat plates.

2. The system according to claim 1, wherein each of the windbreaker elements has a horizontal section of an as airfoil shape.

3. The system according to claim 1, wherein an interval of installation of the windbreaker elements is not more than a chord length of the airfoil shape.

4. The system according to claim 2, wherein an interval of installation of the windbreaker elements is not more than a chord length of the airfoil shape.
